(19) United States
(12) Patent Application Publication
(10) Pub. No.: US 2026/0062356 A1
(43) Pub. Date: Mar. 5, 2026

(54) METHOD FOR MANUFACTURING SINTERED COMPACT AND SINTERED COMPACT

(71) Applicant: NICHIA CORPORATION, Anan-shi (JP)

(72) Inventors: Teruhiko NOGUCHI, Anan-shi (JP); Toshiyuki HIRAI, Komatsushima-shi (JP); Takayuki SHINOHARA, Anan-shi (JP); Shimpei KINOSHITA, Anan-shi (JP)

(73) Assignee: NICHIA CORPORATION, Anan-shi (JP)

(21) Appl. No.: 19/312,253

(22) Filed: Aug. 27, 2025

(30) Foreign Application Priority Data
Aug. 30, 2024 (JP) 2024-148589

(51) Int. Cl. C04B 35/597; C04B 35/626

(52) U.S. Cl. CPC C04B 35/597; C04B 35/62605; C04B 2235/3869; C04B 2235/5409; C04B 2235/658

(57) ABSTRACT

A method for manufacturing a sintered compact is provided, the method including: providing α-sialon phosphor particles; providing a formed body including forming a raw material mixture obtained by mixing the α-sialon phosphor particles and yttrium oxide particles; placing the formed body in a container containing pyrolytic boron nitride; disposing a first lid containing pyrolytic boron nitride at an opening of the container; and obtaining a first sintered compact containing an α-sialon phosphor crystal phase by subjecting the formed body in the container having the opening closed with the first lid to primary firing at a temperature in a range of 1800° C. to 2000° C.

### CROSS-REFERENCE TO RELATED APPLICATION

This application claims priority to Japanese Patent Application No. 2024-148589, filed on Aug. 30, 2024, the disclosure of which is hereby incorporated by reference in its entirety.

### TECHNICAL FIELD

The present disclosure relates to a method for manufacturing a sintered compact and a sintered compact.

### BACKGROUND

Light-emitting devices provided with a light-emitting diode (LED) or a laser diode (LD), and a wavelength conversion member including a phosphor that converts the wavelength of light emitted from the LED or LD are known. Such a light-emitting device is used, for example, as a light source for vehicle-mounted applications, general lighting, a backlight for a liquid crystal display device, or a projector.

As a wavelength conversion member provided in a light-emitting device, for example, Japanese Patent Publication No. 2014-234487 discloses a wavelength conversion member formed of a sintered compact obtained by mixing glass powder and inorganic phosphor powder, melting the glass powder, and solidifying the glass powder.

### SUMMARY

However, in the case of a sintered compact containing a glass component, the glass component may be mixed into the inorganic phosphor during the formation of the sintered compact to hinder the light emission of the phosphor. In addition, glass has a relatively low softening point, and in a case of irradiation with light from a high-output LED or LD, a sintered compact obtained by melting and solidifying the glass powder mixed with the inorganic phosphor powder might not withstand high temperatures.

An object of the present disclosure is to provide a method for manufacturing a sintered compact that has a high relative density and can emit light having a high luminous flux, and is to provide a sintered compact.

A first aspect is a method for manufacturing a sintered compact, including providing α-sialon phosphor particles; providing a formed body comprising forming a raw material mixture obtained by mixing the α-sialon phosphor particles and yttrium oxide particles; placing the formed body in a container containing pyrolytic boron nitride; disposing a first lid containing pyrolytic boron nitride at an opening of the container; and obtaining a first sintered compact containing an α-sialon phosphor crystal phase by subjecting the formed body in the container having the opening closed with the first lid to primary firing at a temperature in a range of 1800° C. to 2000° C.

A second aspect is a sintered compact including an α-sialon phosphor crystal phase and having a relative density of 96% or more.

According to the present disclosure, it is possible to provide a method for manufacturing a sintered compact that has a high relative density and can emit light having a high luminous flux.

### BRIEF DESCRIPTION OF DRAWINGS

FIG. 1 is a flowchart showing a method for manufacturing a sintered compact.

FIG. 2 is a flowchart showing a method for manufacturing a sintered compact.

FIG. 3 is a diagram showing a region A in xy chromaticity coordinates of the CIE 1931 chromaticity diagram.

FIG. 4A is a schematic plan view illustrating an example of a light-emitting device.

FIG. 4B is a schematic cross-sectional view illustrating an example of the light-emitting device.

FIG. 5 shows reflection spectra of α-sialon phosphor particles.

FIG. 6 is a cross-sectional view schematically illustrating a formed body placed in a container containing pyrolytic boron nitride.

FIG. 7A is a photograph showing the appearance of a main surface of a first sintered compact after slicing of each of Examples 1 to 4.

FIG. 7B is a photograph showing the appearance of a main surface of a second sintered compact of each of Examples 1 to 4.

FIG. 8 is a cross-sectional view schematically illustrating a formed body placed in a container containing pyrolytic boron nitride.

FIG. 9 is a photograph showing the appearance of a first sintered compact of Example 7.

FIG. 10 is a photograph showing the appearance of the first sintered compact sliced into a plate-like shape in Example 7.

FIG. 11 is a photograph showing the appearance of a main surface of a second sintered compact of Example 7.

### DETAILED DESCRIPTION

A method for manufacturing a sintered compact and a sintered compact according to the present disclosure are described below on the basis of embodiments. However, the following embodiments are examples for embodying the technical concept of the present invention, and the present invention is not limited to the method for manufacturing a sintered compact and a sintered compact described below. Note that the relationship between the color name and the chromaticity coordinates, and the relationship between the wavelength range of light and the color name of monochromatic light conform to JIS Z 8110. In the present specification, if a plurality of substances corresponding to each component in a composition are present, the content of the component in the composition means the total amount of the plurality of substances present in the composition, unless otherwise specified.

A method for manufacturing a sintered compact includes: providing α-sialon phosphor particles; providing a formed body by forming a raw material mixture obtained by mixing the α-sialon phosphor particles and yttrium oxide particles; placing the formed body in a container containing pyrolytic boron nitride (hereinafter also referred to as “PBN”); disposing a first lid containing pyrolytic boron nitride at an opening of the container; and obtaining a first sintered compact containing an α-sialon phosphor crystal phase by subjecting the formed body in the container in which the opening is closed by the first lid to primary firing at a temperature in a range of 1800° C. to 2000° C.

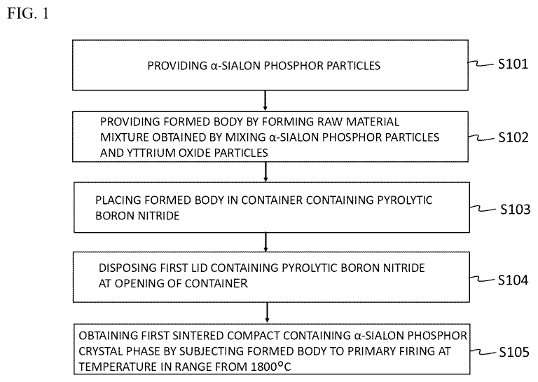

FIG. 1 is a flowchart showing an example of the method for manufacturing a sintered compact. The method for manufacturing a sintered compact includes: S101 of providing α-sialon phosphor particles; S102 of providing a formed body by forming a raw material mixture obtained by mixing the α-sialon phosphor particles and yttrium oxide particles; S103 of placing the formed body in a container containing pyrolytic boron nitride; S104 of disposing a first lid containing pyrolytic boron nitride at an opening of the container; and S105 of obtaining the first sintered compact containing an α-sialon phosphor crystal phase by subjecting the formed body to primary firing at a temperature in a range of 1800° C. to 2000° C.

The method for manufacturing a sintered compact includes providing α-sialon phosphor particles.

In providing the α-sialon phosphor particles, it is preferable that the α-sialon phosphor particles have a BET specific surface area of 2.0 m²/g or more and a light reflectance of 30% or more at a wavelength of 450 nm. When the BET specific surface area of the α-sialon phosphor particles is 2.0 m²/g or more, the BET specific surface area of the α-sialon phosphor particles is relatively large, and in providing a formed body containing the α-sialon phosphor particles, the contact area between the α-sialon phosphor particles or between the α-sialon phosphor particles and the yttrium oxide particles is relatively large, so that a dense sintered compact having a high relative density can be obtained by subjecting the formed body to the primary firing in a container containing the pyrolytic boron nitride. The α-sialon phosphor particles preferably have a BET specific surface area of 5.0 m²/g or less. When the α-sialon phosphor particles have a BET specific surface area of 5.0 m²/g or less, the α-sialon phosphor particles and the yttrium oxide particles can be easily mixed with each other, and a raw material mixture in which the α-sialon phosphor particles and the yttrium oxide particles are substantially uniformly mixed can be formed to provide a formed body. When the α-sialon phosphor particles have a BET specific surface area of 2.0 m²/g or more, the α-sialon phosphor particles are firmly bonded to each other at the time of forming the raw material mixture because of the large BET specific surface area, and a formed body having a high density is obtained. Because the α-sialon phosphor particles in the formed body are firmly bonded to each other, a dense sintered compact having a high relative density is obtained by performing the primary firing in a container containing pyrolytic boron nitride. The BET specific surface area of the α-sialon phosphor particles is more preferably 2.1 m²/g or more, further preferably 2.2 m²/g or more, and still further preferably 2.3 m²/g or more. The BET specific surface area of the α-sialon phosphor particles is more preferably 4.5 m²/g or less, further preferably 4.0 m²/g or less, and still further preferably 3.5 m²/g or less.

When the α-sialon phosphor particles have a reflectance of 30% or more for light with a wavelength of 450 nm, the reactivity of the α-sialon phosphor particles as a raw material of the sintered compact is high. Therefore, when a formed body containing the α-sialon phosphor particles is subjected to the primary firing, a sintered compact can be obtained which absorbs light from an excitation light source having a light emission peak wavelength in a range from 350 nm to 500 nm, and efficiently emits wavelength-converted light, for example.

The α-sialon phosphor particles preferably have a composition represented by the following formula (I′) below.

$${Ca}_{k} {Si}_{12 - ( m + n )} {Al}_{( m + n )} {O}_{n} {N}_{16 - n} : Eu \qquad ( {I}^{′} )$$

(where in the formula (I′), k, m, and n satisfy 1.0≤k≤2.0, 2.0≤m≤6.0, and 0≤n≤1.0, respectively)

When irradiated with the light from an excitation light source having a light emission peak wavelength in a range from 350 nm to 500 nm, the α-sialon phosphor particles preferably emit light having a light emission peak wavelength in a range from 430 nm to 800 nm, more preferably emit light having a light emission peak wavelength in a range from 500 nm to 700 nm, further preferably emit light having a light emission peak wavelength in a range from 550 nm to 650 nm, and still further preferably emit light having a light emission peak wavelength in a range from 550 nm to 600 nm.

The α-sialon phosphor particles preferably have a mean particle diameter (Fisher Sub-sieve sizer's number) of 2.0 μm or less as measured by a Fisher Sub-sieve sizer (FSSS) method. When the mean particle diameter of the nitride phosphor measured by the FSSS method is 2.0 μm or less, a formed body having few voids can be formed. The mean particle diameter of the α-sialon phosphor measured by the FSSS method may be less than 2.0 μm, may be 1.9 μm or less, and may be 1.8 μm or less. The mean particle diameter of the α-sialon phosphor particles measured by the FSSS method may be 0.1 μm or more, may be 0.5 μm or more, and may be 1.0 μm or more. The FSSS method is a kind of air permeability method, and is a method in which the flow resistance of air is utilized to measure a specific surface area of a particle and determine a particle diameter.

As the α-sialon phosphor particles, particles produced as in Examples described later may be used, or commercially available particles may be used.

The method for manufacturing a sintered compact includes forming a raw material mixture obtained by mixing the α-sialon phosphor particles and yttrium oxide particles to provide a formed body.

In providing the formed body, the yttrium oxide particles function as a sintering aid in obtaining the first sintered compact by performing the primary firing described below. It is presumed that when the α-sialon phosphor particles react with each other by the primary firing in the high-density formed body to cause crystal growth, the yttrium oxide particles also react with the α-sialon phosphor particles, part of the elements constituting the composition of the α-sialon phosphor particles is substituted with yttrium, and the reaction between the α-sialon phosphor particles is activated. It is presumed that when the α-sialon phosphor particles react with each other by the primary firing to cause crystal growth in the formed body, part of the elements constituting the composition of the α-sialon phosphor particles is substituted with yttrium to activate the reaction between the α-sialon phosphor particles, which acts on the rate of crystal growth to enable formation of the first sintered compact containing a dense α-sialon phosphor crystal phase with few voids.

In providing the formed body, in the raw material mixture, when the total amount of the α-sialon phosphor particles and the yttrium oxide particles is 100 mass %, the amount of the yttrium oxide particles is preferably in a range from 0.1 mass % to 6.0 mass %, more preferably in a range from 0.1 mass % to 5.5 mass %, and further preferably in a range from 0.1 mass % to 5.0 mass %. In providing the formed body, when the total amount of the α-sialon phosphor particles and the yttrium oxide particles is 100 mass % and the raw material mixture contains yttrium oxide particles in a range from 0.1 mass % to 6.0 mass %, part of the elements constituting the composition of the α-sialon phosphor particles is substituted with yttrium in obtaining the first sintered compact by the primary firing, and the reaction between the α-sialon phosphor particles is activated to act on the rate of crystal growth. Therefore, it is possible to obtain the first sintered compact containing a dense α-sialon phosphor crystal phase with few voids and having a high relative density. Also, after the first sintered compact is obtained, the second sintered compact having a high relative density can also be obtained also by slicing the first sintered compact into a plate-like shape as described below and allowing the sliced compact to secondary firing at a temperature in a range from 1600° C. to 1800° C. When the total amount of the α-sialon phosphor particles and the yttrium oxide particles is 100 mass % and the raw material mixture contains more than 6.0 mass % of yttrium oxide particles, it is presumed that a larger amount of part of the elements constituting the composition of the α-sialon phosphor particles is substituted and a larger amount of decomposition gas is generated. As a result, the obtained second sintered compact may be deformed and the relative density may be lowered. When the total amount of the α-sialon phosphor particles and the yttrium oxide particles is 100 mass %, and the raw material mixture contains 0.1 mass % or less of yttrium oxide particles or substantially does not contain yttrium oxide particles, the amount of yttrium oxide particles that react with the α-sialon phosphor particles is small or the α-sialon phosphor particles and the yttrium oxide particles do not react with each other. As a result, the rate of crystal growth between the α-sialon phosphor particles is less likely to be affected, and the relative density of the obtained first sintered compact may be low.

In the yttrium oxide particles, the purity of yttrium oxide is preferably 96 mass % or more, more preferably 97 mass % or more, further preferably 98 mass % or more, and still further preferably 99 mass % or more. In the yttrium oxide particles, when the purity of yttrium oxide is 96 mass % or more, in obtaining the first sintered compact by the primary firing, part of the elements constituting the composition of the α-sialon phosphor particles is substituted with yttrium, the reaction between the α-sialon phosphor particles is activated, and the first sintered compact having a high relative density can be obtained. As for the purity of yttrium oxide, a value described in a catalog can also be referred to.

The BET specific surface area of the yttrium oxide particles is preferably 3 m²/g or more, more preferably 5 m²/g or more, further preferably 7 m²/g or more, and still further preferably 10 m²/g or more. The BET specific surface area of the yttrium oxide particles is preferably 20 m²/g or less, and more preferably 15 m²/g or less. When the BET specific surface area of the yttrium oxide particles is in a range from 3 m²/g to 20 m²/g, a raw material mixture in which the α-sialon phosphor particles and the yttrium oxide particles are uniformly mixed can be easily obtained, and a formed body having a high density can be obtained.

In providing the formed body, it is preferable that the remainder excluding the yttrium oxide particles in the raw material mixture be the α-sialon phosphor particles. The raw material mixture is preferably composed of the α-sialon phosphor particles and the yttrium oxide particles. It is preferable that the raw material mixture contain the α-sialon phosphor particles and the yttrium oxide particles, and substantially not contain other materials. In the formed body obtained by forming the raw material mixture, the remainder excluding the yttrium oxide particles is preferably the α-sialon phosphor particles. The formed body obtained by forming the raw material mixture is preferably composed of the α-sialon phosphor particles and the yttrium oxide particles. It is preferable that the formed body obtained by forming the raw material mixture contain the α-sialon phosphor particles and the yttrium oxide particles, and substantially do not contain other materials. When the remainder excluding the yttrium oxide particles in the raw material mixture is the α-sialon phosphor particles, in obtaining the first sintered compact by the primary firing, the yttrium oxide particles serve as a sintering aid to substitute part of the elements constituting the composition of the α-sialon phosphor particles with yttrium, thereby activating the reaction between the α-sialon phosphor particles and resulting in obtaining the first sintered compact having a high relative density. When the relative density of the obtained first sintered compact is high, light having a high luminous flux is emitted from the first sintered compact by irradiation with excitation light. Even when the remainder excluding the yttrium oxide particles in the raw material mixture is the α-sialon phosphor particles, and other materials, for example, oxides such as aluminum oxide are substantially not contained, a dense first sintered compact having a high relative density is obtained. When the raw material mixture contains an oxide other than yttrium oxide, for example, aluminum oxide, the aluminum oxide shrinks due to the heat of firing during performing the firing, and the obtained sintered compact is densified, so that the relative density of the sintered compact may increase. In providing the formed body, even in the case in which the remainder excluding the yttrium oxide particles in the raw material mixture is the α-sialon phosphor particles and the raw material mixture substantially does not contain anything other than the α-sialon phosphor particles and the yttrium oxide particles, a dense first sintered compact having a high relative density is obtained by subjecting the formed body to the primary firing in a container containing pyrolytic boron nitride.

In providing the formed body, in the raw material mixture, the amount of the α-sialon phosphor particles is preferably in a range from 94 mass % to 99.9 mass %, more preferably in a range from 95 mass % to 99.8 mass %, further preferably in a range from 96 mass % to 99.7 mass %, and still further preferably in a range from 97 mass % to 99.5 mass % with respect to 100 mass % of the total amount of the α-sialon phosphor particles and the yttrium oxide particles. In providing the formed body, when the raw material mixture contains the α-sialon phosphor particles in a range from 94 mass % to 99.9 mass % with respect to 100 mass % of the total amount of the α-sialon phosphor particles and the yttrium oxide particles, a dense first sintered compact that has a high relative density is obtained by the primary firing. The obtained first sintered compact can emit light having a high luminous flux by irradiation with excitation light. The raw material mixture may be composed of only the α-sialon phosphor particles and the yttrium oxide particles, or the amount of the α-sialon phosphor particles may be in a range from 94 mass % to 99.9 mass % and the amount of the yttrium oxide particles may be in a range from 0.1 mass % to 6 mass % with respect to 100 mass % of the raw material mixture. In the raw material mixture, with respect to 100 mass % of the raw material mixture, the amount of the α-sialon phosphor particles may be in a range from 95 mass % to 99.8 mass % and the amount of the yttrium oxide particles may be in a range from 0.2 mass % to 5 mass %, the amount of the α-sialon phosphor particles may be in a range from 96 mass % to 99.7 mass % and the amount of the yttrium oxide particles may be in a range from 0.3 mass % to 4 mass %, and the amount of the α-sialon phosphor particles may be in a range from 97 mass % to 99.5 mass % and the amount of the yttrium oxide particles may be in a range from 0.5 mass % to 3 mass %.

In providing the formed body, the α-sialon phosphor particles and the yttrium oxide particles can be mixed by dry mixing. The dry mixing may be performed using a mortar and a pestle, or may be performed using a mixer such as a ball-mill and a medium such as media. By performing the dry mixing, the α-sialon phosphor particles and the yttrium oxide particles can be uniformly mixed, and aggregation of the particles can be reduced. In providing the formed body, it is preferable not to add a forming aid to the raw material mixture. It is presumed that when the raw material mixture is placed in a container containing pyrolytic boron nitride and subjected to the primary firing, components volatilized from the α-sialon phosphor particles are present in the container to increase the internal pressure of the container, and the reaction between the α-sialon phosphor particles is activated. It is preferable that the formed body obtained by forming the raw material mixture substantially not contain a volatile component such as a forming aid. In a case in which the raw material mixture contains the forming aid, the amount of the forming aid is preferably 10 parts by mass or less, more preferably 9 parts by mass or less, still more preferably 8 parts by mass or less, and may be 0.1 parts by mass or more when the amount of the raw material mixture is 100 parts by mass. The forming aid is preferably a liquid other than water, and examples thereof include methanol, ethanol, and the like.

In providing the formed body, as a method of forming the raw material mixture, for example, a known method such as a press forming method or a cold isostatic pressing (CIP) method can be employed. Examples of the press forming method include a die press molding method, and CIP for which the term is defined in JIS Z2500:2000, No. 2109. In addition, the raw material mixture may be uni-axially compressed and formed. Two types of forming methods for the raw material mixture may be used to shape the formed body. For example, CIP may be performed after press forming with a molding die, or the raw material mixture may be uni-axially compressed by a roller bench method, followed by CIP. With CIP, a formed body is preferably pressed by cold isostatic pressing using water as a medium.

The pressure for die press molding or the pressure for uni-axially compressing and forming is preferably in a range from 2 MPa to 50 MPa, and more preferably in a range from 2 MPa to 30 MPa. When the pressure for die press molding or the pressure for uni-axially compressing and forming is in the range described above, the formed body can be formed into a desired shape. When the pressure for die press molding or the pressure for uni-axially compressing and forming exceeds 50 MPa, forming cracks may be generated when the particle diameter of the α-sialon phosphor particles contained in the raw material mixture is small.

The pressure for CIP is preferably in a range from 50 MPa to 500 MPa, and more preferably in a range from 50 MPa to 360 MPa. When the pressure for CIP is in a range from 50 MPa to 360 MPa, a formed body having a high density is obtained.

A method for manufacturing a sintered compact includes placing a formed body in a container containing pyrolytic boron nitride.

In placing the formed body in a container, the container in which the formed body is placed preferably contains pyrolytic boron nitride. The container in which the formed body is placed is preferably a pyrolytic boron nitride (PBN) crucible. The PBN crucible is preferably manufactured by a reduced-pressure pyrolysis chemical vapor deposition (CVD) method. The PBN crucible is preferable because of high purity of boron nitride, high density, low outgassing even at high temperatures, and good heat resistance and thermal conductivity. The container may have any size as long as the container has a volume enough for placement of the formed body. Because the container containing pyrolytic boron nitride is dense, the decomposition gas resulting from decomposition and gasification of the α-sialon phosphor particles in the formed body by the heat of the primary firing is less likely to be released to the outside of the container and is likely to be present around the formed body. Therefore, the reaction between the α-sialon phosphor particles is promoted and a first sintered compact having a high relative density is likely to be obtained.

In placing the formed body in the container, the formed body is preferably placed such that at least one surface of the formed body is in contact with the bottom surface of the container. By placing the formed body such that at least one surface of the formed body is in contact with the bottom surface of the container, the primary firing can be performed in a state where the formed body is stably placed in the container.

The placing of the formed body in the container preferably includes disposing a second lid containing pyrolytic boron nitride in the container such that second lid is in contact with the formed body in the container. It is presumed that when the second lid containing pyrolytic boron nitride is disposed in contact with the formed body in the container, the decomposition gas resulting from decomposition and gasification of the α-sialon phosphor particles in the formed body by the heat of the primary firing is likely to be present at a higher concentration around the formed body, and the internal pressure around the formed body can be made higher, thereby acting on the crystal growth between the α-sialon phosphor particles to easily obtain the first sintered compact having a high relative density. The second lid containing pyrolytic boron nitride is preferably a plate-like body having an area larger than that of one surface of the formed body in contact with the second lid. When the second lid having an area larger than the surface of the formed body in contact with the container is disposed in the container so as to be in contact with the formed body, the decomposition gas generated by decomposition of the α-sialon phosphor particles in the formed body by the heat of the primary firing is likely to be present around the formed body. The second lid containing pyrolytic boron nitride may have any size as long as it can be disposed in the container. When the container in which the formed body is placed is a cylindrical container having a bottom surface, the second lid preferably has a diameter smaller than the inner diameter of the container. The second lid containing pyrolytic boron nitride may have the same thickness as the formed body, and preferably has a thickness smaller than the thickness of the formed body. The second lid is preferably a second lid formed of pyrolytic boron nitride (PBN), and is preferably a second lid formed of PBN manufactured by a reduced-pressure pyrolysis CVD method. The second lid formed of PBN is preferable because of high purity of boron nitride, high density, low outgassing even at high temperatures, and good heat resistance and thermal conductivity.

A method for manufacturing a sintered compact includes disposing a first lid containing pyrolytic boron nitride at an opening of a container.

In disposing the first lid, by disposing the first lid containing pyrolytic boron nitride at the opening of the container in which the formed body is placed, the decomposition gas resulting from the decomposition of the α-sialon phosphor particles in the formed body by the heat of the primary firing is not released to the outside of the container, the internal pressure of the container becomes high, thereby acting on the crystal growth between the α-sialon phosphor particles to obtain the first sintered compact having a high relative density. The size of the first lid may be any size as long as the first lid closes the opening of the container. The first lid is preferably a first lid formed of pyrolytic boron nitride (PBN), and is preferably a first lid formed of PBN manufactured by a reduced-pressure pyrolysis CVD method. The first lid formed of PBN is preferable because of high purity of boron nitride, high density, low outgassing even at high temperatures, and good heat resistance and thermal conductivity.

The disposing of the first lid preferably includes applying a load to the first lid. By applying a load to the first lid, the gap between the container and the first lid can be reduced. By applying a load to the first lid to reduce the gap between the container and the first lid, the decomposition gas of the α-sialon phosphor particles decomposed by the primary firing is less likely to be released to the outside of the container, the internal pressure in the container can be further increased, and the first sintered compact having a higher relative density can be obtained.

The applying a load to the first lid preferably includes disposing a weight on the first lid. By disposing the weight on the first lid, the gap between the opening of the container containing pyrolytic boron nitride and the first lid is further reduced, the release of the decomposition gas of the α-sialon phosphor particles decomposed by the primary firing to the outside of the container is further reduced, the internal pressure in the container can be further increased, and the first sintered compact having a higher relative density can be obtained. The weight preferably contains at least one selected from the group consisting of tungsten, molybdenum, and tantalum. The weight is preferably a material that substantially does not react with boron nitride contained in the first lid, and is preferably a material that has a high true density and can withstand the temperature of the primary firing. When the weight is a metal containing at least one selected from the group consisting of tungsten, molybdenum, and tantalum, or an alloy containing two or more selected from the group consisting of tungsten, molybdenum, and tantalum, the weight is disposed on the first lid without reacting with boron nitride contained in the container. Thus, the gap between the container and the first lid is reduced.

The method for manufacturing a sintered compact includes subjecting the formed body in the container in which the opening is closed with the first lid to the primary firing at a temperature in a range from 1800° C. to 2000° C. to obtain the first sintered compact containing an α-sialon phosphor crystal phase.

In obtaining the first sintered compact, the formed body in the container in which the opening is closed with the first lid is subjected to the primary firing at a temperature in the range from 1800° C. to 2000° C., whereby the α-sialon phosphor particles contained in the formed body react with each other to cause crystal growth, the decomposition gas resulting from decomposition of part of the α-sialon phosphor particles by the primary firing is not released to the outside of the container to increase the internal pressure of the container, and the first sintered compact having a high relative density can be obtained. In addition, in obtaining the first sintered compact, the α-sialon phosphor particles and the yttrium oxide particles contained in the formed body also react with each other to promote crystal growth between the α-sialon phosphor particles, and the internal pressure of the container is also increased by the decomposition gas of the α-sialon phosphor particles, so that the first sintered compact having few voids and a high relative density is obtained.

In obtaining the first sintered compact, the temperature of the primary firing is in a range from 1800° C. to 2000° C., preferably in a range from 1825° C. to 1975° C., and more preferably in a range from 1850° C. to 1950° C. When the temperature of the primary firing is in the range from 1800° C. to 2000° C., the reaction between the α-sialon phosphor particles contained in the formed body with each other and the reaction between the α-sialon phosphor particles and the yttrium oxide particles are promoted, and therefore, the first sintered compact containing the α-sialon phosphor crystal phase and a sub-phase can be obtained.

In obtaining the first sintered compact, examples of the method for performing the primary firing include an atmosphere sintering method in which firing is performed in a non-oxidizing atmosphere without applying pressure or a load, and an atmosphere pressure sintering method in which firing is performed under pressure in a non-oxidizing atmosphere.

The obtaining of the first sintered compact preferably includes performing the primary firing in a non-oxidizing atmosphere pressurized in a range from 0.5 MPa to 200 MPa. By performing the primary firing in a pressurized atmosphere in the range from 0.5 MPa to 200 MPa, even when the primary firing is performed at a high temperature in a range from 1800° C. to 2000° C., the likelihood of the decomposition of the α-sialon phosphor particles contained in the formed body can be reduced, and the decomposition gas resulting from the decomposition of the α-sialon phosphor particles is not released to the outside from the container containing the pyrolytic boron nitride but remains in the container to increase the internal pressure in the container, so that the first sintered compact having a high relative density is obtained. In obtaining the first sintered compact, it is more preferable to perform the primary firing in a non-oxidizing atmosphere in a range from 0.8 MPa to 150 MPa, and is further preferable to perform the primary firing in a non-oxidizing atmosphere in a range from 1.0 MPa to 100 MPa. The pressure of the atmosphere at the time of performing the primary firing refers to a gauge pressure.

In obtaining the first sintered compact, the non-oxidizing atmosphere in which the primary firing is performed is preferably an atmosphere containing nitrogen gas. The non-oxidizing atmosphere in which secondary firing described later is performed is also preferably an atmosphere containing nitrogen gas. The atmosphere containing nitrogen gas in the primary firing and the secondary firing is preferably an atmosphere containing at least 99 vol % or more of nitrogen. The content of nitrogen in the atmosphere containing the nitrogen gas is preferably 99 vol % or more, and is more preferably 99.5 vol % or more. The atmosphere containing the nitrogen gas may contain a trace amount of gas such as oxygen in addition to nitrogen, but the content of oxygen in the atmosphere containing the nitrogen gas is preferably 1 vol % or less, more preferably 0.5 vol % or less, further preferably 0.1 vol % or less, still further preferably 0.01 vol % or less, and particularly preferably 0.001 vol % or less. The non-oxidizing atmosphere in which the primary firing and the secondary firing are performed may be an atmosphere containing nitrogen having a reducing property or may be an atmosphere containing hydrogen gas and nitrogen. When hydrogen gas is contained in the atmosphere containing nitrogen, the content of hydrogen gas in the atmosphere is preferably 1 vol % or more, more preferably 5 vol % or more, and still more preferably 10 vol % or more. The atmosphere for heat treatment may be a reducing atmosphere using solid carbon in an air atmosphere.

In obtaining the first sintered compact, the time for the primary firing may be appropriately selected depending on the pressure of the atmosphere. In obtaining the first sintered compact, the time for the primary firing is in a range from 0.5 hours to 20 hours, for example, and preferably in a range from 1 hour to 10 hours.

The method for manufacturing a sintered compact preferably includes slicing the first sintered compact into a plate-like shape, and subjecting the sliced plate-like first sintered compact to the secondary firing at a temperature of 1600° C. or more and less than 1800° C. to obtain the second sintered compact containing an α-sialon phosphor crystal phase.

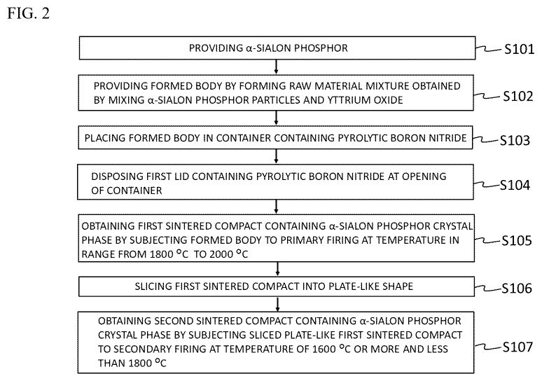

FIG. 2 is a flowchart showing an example of the method for manufacturing a sintered compact. As in FIG. 1, the method for manufacturing a sintered compact includes: S101 of providing α-sialon phosphor particles; S102 of providing a formed body by forming a raw material mixture obtained by mixing the α-sialon phosphor particles and yttrium oxide particles; S103 of placing the formed body in a container containing pyrolytic boron nitride; S104 of disposing the first lid containing pyrolytic boron nitride at the opening of the container; and S105 of obtaining the first sintered compact containing an α-sialon phosphor crystal phase by subjecting the formed body to primary firing at a temperature in a range from 1800° C. to 2000° C. It is preferable that the method for manufacturing a sintered compact further include: S106 of slicing the first sintered compact into a plate-like shape; and S107 of obtaining the second sintered compact containing an α-sialon phosphor crystal phase by subjecting the sliced plate-like first sintered compact to the secondary firing at a temperature of 1600° C. or more and less than 1800° C.

The method for manufacturing a sintered compact preferably includes slicing the first sintered compact into a plate-like shape. The body color of the first sintered compact obtained by the primary firing is dull in some cases. By performing the secondary firing in a state where the first sintered compact is sliced into a plate-like shape, the dull body color can be returned to the original body color. “The body color of the first sintered compact is dull” means that the body color of the first sintered compact is different from the body color of the α-sialon phosphor crystal phase. “The body color of the first sintered compact returns to the original body color” means that the body color returns to the original body color of the α-sialon phosphor crystal phase.

The slicing preferably includes slicing the first sintered compact to a thickness of 2 mm or less. The body color of the first sintered compact obtained by the primary firing is dull in some cases. “The body color of the first sintered compact is dull” means that the body color is dark unlike the body color of the α-sialon phosphor crystal phase. By performing the secondary firing in a state where the first sintered compact is sliced to a thickness of 2 mm or less, the dull body color inside the first sintered compact can be returned to the original body color of the α-sialon phosphor, and the α-sialon phosphor crystal phase can be contained. In the slicing, the first sintered compact may be sliced to a thickness of 1.5 mm or less, or may be sliced to a thickness of 1 mm or less. In the slicing, in consideration of the strength of the first sintered compact, the first sintered compact may be sliced to a thickness of 0.1 mm or more, or may be sliced to a thickness of 0.15 mm or more.

In the slicing, the first sintered compact is preferably sliced using blade dicing, laser dicing, or a wire saw. It is preferable to slice the first sintered compact using a wire saw from the viewpoint where a cut surface obtained by slicing the first sintered compact is flat with high precision.

The method for manufacturing a sintered compact preferably includes subjecting the sliced first sintered compact to the secondary firing at a temperature of 1600° C. or more and less than 1800° C. to obtain the second sintered compact containing an α-sialon phosphor crystal phase. By subjecting the sliced first sintered compact to the secondary firing at a temperature of 1600° C. or more and less than 1800° C., it is possible to obtain the second sintered compact returned to the original body color of the α-sialon phosphor crystal phase in a case in which the body color of the first sintered compact is dull due to the primary firing. In obtaining the second sintered compact, by subjecting the sliced first sintered compact to the secondary firing, it is possible to obtain the second sintered compact in which not only the surface but also the interior is returned to the original body color of the α-sialon phosphor crystal phase.

In obtaining the second sintered compact, the temperature for the secondary firing is preferably lower than the temperature for the primary firing. The temperature for the secondary firing is preferably 1600° C. or more and less than 1800° C., more preferably in a range from 1650° C. to 1790° C., further preferably in a range from 1660° C. to 1780° C., and still further preferably in a range from 1670° C. to 1770° C. When the temperature at which the sliced first sintered compact is subjected to the secondary firing is 1600° C. or more and less than 1800° C., impurities that cause dullness and have a composition different from the compositions of the α-sialon phosphor crystal phase and the sub-phase contained in the first sintered compact are released as a gas, and therefore, the second sintered compact returned to the original body color of the α-sialon phosphor crystal phase can be obtained.

In obtaining the second sintered compact, examples of the method for performing the secondary firing include an atmosphere sintering method in which firing is performed in a non-oxidizing atmosphere without applying pressure or a load, and an atmosphere pressure sintering method in which firing is performed under pressure in a non-oxidizing atmosphere. In obtaining the second sintered compact, it is preferable to place the first sintered compact in a firing furnace and perform the secondary firing. In obtaining the second sintered compact, the first sintered compact placed in a container is placed in a firing furnace and the first sintered compact can be subjected to the secondary firing.

The obtaining of the second sintered compact preferably includes placing the first sintered compact in a container containing pyrolytic boron nitride, and disposing the first lid containing pyrolytic boron nitride at an opening of the container. In obtaining the second sintered compact, by placing the first sintered compact in the container containing pyrolytic boron nitride and disposing the first lid containing pyrolytic boron nitride at the opening of the container, the decomposition gas resulting from decomposition and gasification of the α-sialon phosphor particles by the heat of the secondary firing is less likely to be released to the outside of the container, and is present around the formed body to increase the internal pressure of the container, so that the second sintered compact returned to the original body color of the α-sialon phosphor crystal phase can be obtained without reducing the relative density.

The obtaining of the second sintered compact preferably includes applying a load to the first lid. By applying a load to the first lid, the gap between the container and the first lid is reduced, the internal pressure in the container is further increased, and the second sintered compact returned to the original body color of the α-sialon phosphor crystal phase can be obtained without reducing the relative density.

The obtaining the second sintered compact preferably includes performing the secondary firing in a non-oxidizing atmosphere pressurized in a range from 0.5 MPa to 200 MPa. By performing the secondary firing in a pressurized atmosphere in the range from 0.5 MPa to 200 MPa, the likelihood of decomposition of the α-sialon phosphor particles contained in the first sintered compact is reduced, and impurities having a composition other than the composition of the α-sialon phosphor crystal phase and the composition of the sub-phase are decomposed and released as a gas, so that a second sintered compact returned to the original body color of the α-sialon phosphor crystal phase can be obtained. In obtaining the second sintered compact, it is more preferable to perform the secondary firing in a non-oxidizing atmosphere in a range from 0.8 MPa to 150 MPa, and is further preferable to perform the secondary firing in a non-oxidizing atmosphere in a range from 1.0 MPa to 100 MPa. The pressure of the atmosphere at the time of performing the secondary firing refers to a gauge pressure.

The non-oxidizing atmosphere in which the secondary firing is performed is preferably an atmosphere containing nitrogen gas. The non-oxidizing atmosphere in which the secondary firing is performed may be the same as or different from the atmosphere in which the primary firing is performed. The non-oxidizing atmosphere in the secondary firing is the same or similar atmosphere as the non-oxidizing atmosphere in the primary firing.

In obtaining the second sintered compact, the time for the secondary firing is preferably in a range from 1 hour to 5 hours. When the time for the secondary firing is in a range from 1 hour to 3 hours, impurities such as crystals having a composition different from the composition of the nitride phosphor generated inside the first sintered compact are decomposed and easily released as a gas while the decomposition of the crystal structure having the composition of the nitride phosphor contained in the first sintered compact is reduced. The time for the secondary firing may be in a range from 1 hour to 2 hours.

The sintered compact contains an α-sialon phosphor crystal phase and has a relative density of 96% or more. In the present specification, the sintered compact includes the first sintered compact and the second sintered compact obtained by the above-described method for manufacturing a sintered compact. The sintered compact contains an α-sialon phosphor crystal phase, has a relative density of 96% or more, and can emit light having a high luminous flux by irradiation with light. The relative density of the sintered compact is preferably 97% or more, and more preferably 98% or more to allow the sintered compact to emit light having a high luminous flux by light irradiation. The relative density of the sintered compact may be 100% or 99% or less. Even when the sintered compact contains the α-sialon phosphor crystal phase and the sub-phase, in a case in which the raw material mixture is assumed to consist only of the α-sialon phosphor particles, the value obtained by multiplying 100 mass % of the raw material mixture by the true density of the α-sialon phosphor particles is the true density of the sintered compact, and the relative density may exceed 100%.

The relative density of the sintered compact refers to a value calculated from the apparent density of the sintered compact with respect to the true density of the sintered compact. The relative density of the sintered compact is calculated by the following calculation formula (1). The sintered compacts represented by the following calculation formulas (1) and (2) include the first sintered compact and the second sintered compact.

$$\begin{matrix}[ Equation 1 ] & \\ Relative density of sintered compact ( \% ) = \frac{Apparent density of sintered compact}{True density of sintered compact} \times 100 & ( 1 )\end{matrix}$$

As for the true density of the sintered compact, when the raw material mixture is assumed to be composed of α-sialon phosphor particles, the value obtained by multiplying 100 mass % of the raw material mixture by the true density of the α-sialon phosphor particles is the true density of the sintered compact.

The apparent density of the sintered compact is a value obtained by dividing the mass of the sintered compact by the volume of the sintered compact, which is determined by the Archimedes method, and is calculated by the following calculation formula (2). In the following calculation formula (2), the volume of the sintered compact refers to a volume determined by the Archimedes method.

$$\begin{matrix}[ Equation 2 ] & \\ Apparent density of sintered compact ( g / {cm}^{3} ) = \frac{Mass of sintered compact ( g )}{Volume of sintered compact ( {cm}^{3} )} & ( 2 )\end{matrix}$$

When the sub-phase contained in the sintered compact or the yttrium oxide particles contained in the raw material mixture are taken into consideration in the true density of the sintered compact, the true density of the sintered compact is calculated by the following calculation formula (3).

$$\begin{matrix}[ Equation 3 ] & \\ True density of sintered compact ( g / {cm}^{3} ) = 100 / ( {A}_{v} + {B}_{v} ) & ( 3 )\end{matrix}$$

$$Volume of α - sialon phosphor in sintered compact ( {cm}^{3} ) : {A}_{v}$$

$$Volume of yttrium oxide particles in sintered compact ( {cm}^{3} ) : {B}_{v}$$

The volume of the α-sialon phosphor contained in the sintered compact is calculated by the following calculation formula (4).

[Equation 4]

Volume of α-sialon phosphor in sintered compact (cm³)=Mass ratio of α-sialon phosphor in sintered compact (%)/true density of α-sialon phosphor (g/cm³) (4)

The volume of yttrium oxide contained in the sintered compact is calculated by the following calculation formula (5).

[Equation 5]

Volume of yttrium oxide in sintered compact (cm³)=Mass ratio of yttrium oxide in sintered compact (%)/true density of yttrium oxide (g/cm³) (5)

The α-sialon phosphor crystal phase contained in the sintered compact preferably has a composition represented by the following formula (I). When the α-sialon phosphor crystal phase contained in the sintered compact has the composition represented by the following formula (I), the sintered compact can emit light having a high relative luminous flux, a light emission peak wavelength in a desired wavelength range, and a desired color, by irradiation with light.

(Ca_{1-q}Y_{q})ₖSi₁₂₋₍ₘ₊ₙ₎Al₍ₘ₊ₙ₎OₙN₁₆₋ₙ:Eu (I)

(where in the formula (I), k, m, n, and q satisfy 1.0≤k≤2.0, 2.0≤m≤6.0, 0≤n≤1.0, and 0.001≤q≤0.35, respectively)

In the composition of the α-sialon phosphor crystal phase represented by the formula (I), the numerical values represented by a variable q and a variable k represent the molar ratio of yttrium contained in 1 mol of the composition of the α-sialon phosphor crystal phase. In the composition represented by the formula (I) above, the variable q may be in a range from 0.001 to 0.32 (0.001≤q≤0.32), may be in a range from 0.002 to 0.31 (0.002≤q≤0.31), or may be in a range from 0.003 to 0.30 (0.003≤q≤0.30).

The α-sialon phosphor crystal phase contained in the sintered compact may have a composition represented by the following formula (I′). The composition represented by the following formula (I′) is the same as that of the α-sialon phosphor particles contained in the raw material mixture.

$${Ca}_{k} {Si}_{12 - ( m + n )} {Al}_{( m + n )} {O}_{n} {N}_{16 - n} : Eu \qquad ( {I}^{′} )$$

(where in the formula (I′), k, m, and n satisfy 1.0≤k≤2.0, 2.0≤m≤6.0, and 0≤n≤1.0, respectively)

The sintered compact may contain an α-sialon phosphor crystal phase in which calcium contained in the composition of the α-sialon phosphor particles contained in the raw material mixture is not substituted with yttrium and the composition of the α-sialon phosphor particles remains unchanged.

It is preferable that the sintered compact contain an α-sialon phosphor crystal phase and a sub-phase, and the sub-phase have a composition represented by the following formula (II).

Ca₂Si₅N₈ (II)

When the sintered compact contains the sub-phase having a composition different from that of the α-sialon phosphor crystal phase, the light emitted to the sintered compact is scattered by the sub-phase, the light is absorbed by the α-sialon phosphor crystal phase to facilitate wavelength conversion, and the sintered compact can emit fluorescence having a high luminous flux subjected to wavelength conversion.

In the sintered compact, when the total content of the α-sialon phosphor crystal phase and the sub-phase is 100 vol %, the content of the sub-phase is preferably 20 vol % or less, the content of the sub-phase is preferably in a range from 1 vol % to 20 vol %, more preferably in a range from 2 vol % to 18 vol %, and further preferably in a range from 3 vol % to 15 vol %. When the content ratio of the sub-phase in the sintered compact is in a range from 1 vol % to 20 vol % with respect to 100 vol % of the total content of the α-sialon phosphor crystal phase and the sub-phase, incident light is scattered by the sub-phase and absorbed by the α-sialon phosphor crystal phase even in a case in which the relative density is as high as 96% or more and the sintered compact substantially does not contain voids, so that the color unevenness of light emitted from the first sintered compact can be reduced. The content ratio of the α-sialon phosphor crystal phase and the content ratio of the sub-phase in the sintered compact can be measured by a quantitative analysis method based on an X-ray diffraction spectrum using an X-ray diffractometer (for example, the product name: Ultima IV, manufactured by Rigaku Corporation).

The sintered compact can be used as a wavelength conversion member. The sintered compact used as a wavelength conversion member coverts the wavelength of emitted light having a light emission peak wavelength, for example, in a range from 380 nm to 570 nm and preferably emits light having colors in the region A in the CIE 1931 chromaticity diagram, when chromaticity coordinates (x=0.549, y=0.425) are assumed to be a first A point, chromaticity coordinates (x=0.562, y=0.438) are assumed to be a second A point, chromaticity coordinates (x=0.589, y=0.411) are assumed to be a third A point, and chromaticity coordinates (x=0.576, y=0.407) are assumed to be a fourth A point, the region A being defined by a straight line connecting the first A point and the second A point, a straight line connecting the second A point and the third A point, a straight line connecting the third A point and the fourth A point, and a straight line connecting the fourth A point and the first A point.

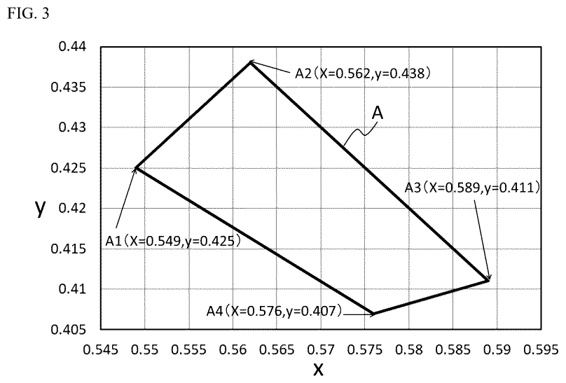

FIG. 3 is a diagram showing the region A in xy chromaticity coordinates of the CIE 1931 chromaticity diagram. Light having a color in the region A in the chromaticity diagram exhibits an orange emission color.

The light-emitting device is configured by combining the sintered compact obtained by the above-described manufacturing method as a wavelength conversion member with a light-emitting element such as an LED or an LD. The light-emitting device converts the excitation light emitted from the light-emitting element by the sintered compact and emits light having a desired light emission peak wavelength. The light-emitting device emits mixed-color light of light from the light-emitting element and light that is subjected to wavelength conversion by the sintered compact. The light-emitting device may use a combination of the above-described sintered compact containing the α-sialon phosphor crystal phase with another sintered compact containing a phosphor crystal phase other than the α-sialon phosphor crystal phase.

The light-emitting element preferably has a light emission peak wavelength in a range from 350 nm to 500 nm, more preferably has a light emission peak wavelength in a range from 360 nm to 480 nm, and more preferably has a light emission peak wavelength in a range from 380 nm to 460 nm. A semiconductor light-emitting element using, for example, a nitride semiconductor (In_{X}Al_{Y}Ga_{1-X-Y}N, 0≤X, 0≤Y, X+Y≤1) is preferably used as the light-emitting element. By using a semiconductor light-emitting element as an excitation light source, a stable light-emitting device that exhibits high efficiency and high output linearity with respect to an input and that is strong against mechanical impact can be obtained.

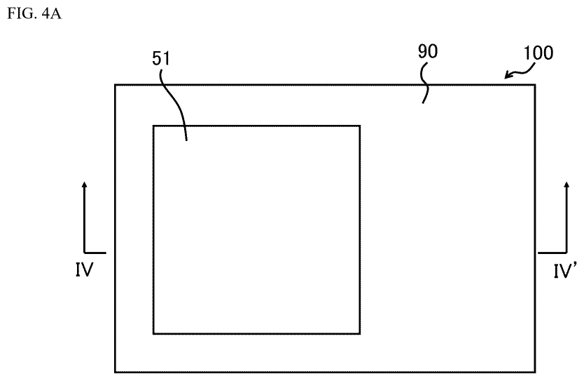

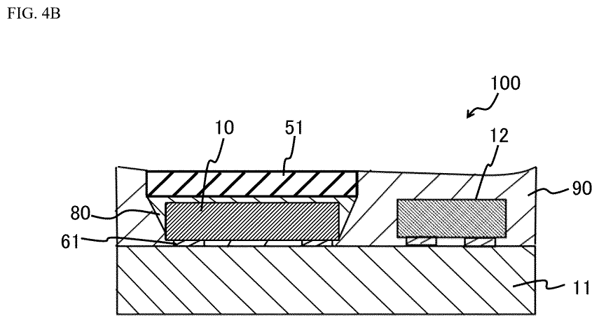

FIGS. 4A and 4B illustrate configuration examples of a light-emitting device using a sintered compact as a wavelength conversion member. FIG. 4A is a schematic plan view of a light-emitting device 100. FIG. 4B is a schematic cross-sectional view taken along line IV-IV′ of the light-emitting device 100 illustrated in FIG. 4A. The light-emitting device 100 includes a light-emitting element 10 having a light emission peak wavelength in a range from 350 nm to 500 nm and a wavelength conversion member 51 that emits light when excited by light from the light-emitting element 10. The light-emitting element 10 is flip-chip mounted over a substrate 11 via a bump, which is a conductive member 61. The wavelength conversion member 51 is disposed over the light-emitting surface of the light-emitting element 10 via an adhesive layer 80. The lateral surfaces of the light-emitting element 10 and the wavelength conversion member 51 are covered with a cover member 90 that reflects light. The light-emitting element 10 receives a supply of electric power from outside of the light-emitting device 100 through wirings and the conductive member 61 formed on the substrate 11, and can make the light-emitting device 100 emit light. The light-emitting device 100 may include a semiconductor element 12 such as a protective element for preventing the light-emitting element 10 from being damaged by the application of excessive voltage. The semiconductor element 12 may be mounted on the substrate 11 via the conductive member 61. The cover member 90 is disposed so as to cover the semiconductor element 12, for example. Each of the members used in the light-emitting device will be described below. For details, reference may be made to the disclosure of Japanese Patent Publication No. 2014-112635, for example.

The adhesive layer is preferably formed of a material that can optically couple the light-emitting element and the wavelength conversion member. The material constituting the adhesive layer is preferably at least one type of resin selected from the group consisting of epoxy resin, silicone resin, phenol resin, and polyimide resin. The light-emitting element and the wavelength conversion member may be directly bonded to each other without the adhesive layer.

Examples of the semiconductor element provided as necessary in the light-emitting device include, for example, a transistor for controlling the light-emitting element and a protective element for reducing damage or performance deterioration of the light-emitting element due to the application of excessive voltage. An example of the protective element is a Zener diode. When the light-emitting device is provided with a cover member, an insulating material is preferably used as the material of the cover member. More specific examples of the material of the cover member include phenol resin, epoxy resin, bismaleimide triazine resin (BT resin), polyphthalamide (PPA) resin, and silicone resin. A coloring agent, a phosphor, or a filler may be added to the cover member as necessary. The light-emitting device may use a bump as the conductive member. Au or a Au alloy can be used as the material of the bump, and other examples of the conductive member include eutectic solder (Au—Sn), Pb—Sn, and lead-free solder.

An example of a method for manufacturing the light-emitting device is described. For details, reference may be made to the disclosure of Japanese Patent Publication No. 2014-112635 or Japanese Patent Publication No. 2017-117912, for example. The method for manufacturing the light-emitting device preferably includes a step of disposing a light-emitting element, a step of disposing a semiconductor element as necessary, a step of providing a wavelength conversion member, a step of bonding the light-emitting element and the wavelength conversion member, and a step of disposing a cover member.

For example, in the step of disposing the light-emitting element, the light-emitting element is disposed on a substrate. The light-emitting element and the semiconductor element are, for example, flip-chip mounted on the substrate. In the step of providing the wavelength conversion member, a wavelength conversion member formed of the ceramic sintered compact obtained by the above-described manufacturing method is provided. Subsequently, in the step of bonding the light-emitting element and the wavelength conversion member to each other, the provided wavelength conversion member is bonded to the light-emitting element via the adhesive layer with the wavelength conversion member facing the light-emitting surface of the light-emitting element. Subsequently, in the step of disposing the cover member, the lateral surfaces of the light-emitting element and the wavelength conversion member are covered with the cover member. The cover member is for reflecting light emitted from the light-emitting element, and is preferably disposed such that when the light-emitting device also includes a semiconductor element, the semiconductor element is embedded in the cover member. In this manner, the light-emitting device illustrated in FIGS. 4A and 4B can be manufactured.

### EXAMPLES

The present invention will be specifically described hereinafter using examples. However, the present invention is not limited to these examples.

### Production of α-Sialon Phosphor Particles 1

Ca₃N₂, EuN, Si₃N₄, and AlN were used as raw materials, and each of the compounds was weighed in a glove box in an inert gas atmosphere such that the molar ratio of each element in the preparation composition in the raw material mixture was Ca:Eu:Si:Al=1.7:0.05:8.5:3.5, and the compounds were mixed to obtain a phosphor raw material mixture. In the preparation composition of the phosphor raw material mixture, the molar ratio of the total of Si and Al was set to 12, and the molar ratio of each element was derived. The obtained phosphor raw material mixture of the α-sialon phosphor is supplied into a PBN crucible, and the phosphor raw material mixture is subjected to heat treatment at 1600° C. for 5 hours in an atmosphere containing 99.9 vol % or more of nitrogen and the remainder of oxygen (0.1 vol % or less) under a gas pressure of 0.9 MPa gauge pressure to obtain a fired product. The obtained fired product was dispersed because the particles were sintered with each other, and then subjected to sieve classification to remove coarse particles and fine particles, so that α-sialon phosphor particles 1 having a composition represented by the formula (I′) were obtained. In the composition represented by the formula (I′) of the obtained α-sialon phosphor particles 1, k is 1.66, the sum of m and n (m+n) is 3.48, the molar ratio of Si is 8.52, and the molar ratio of Eu is 0.05. Elemental analysis of the composition of the α-sialon phosphor particles was performed by the method described below.

### Production of α-Sialon Phosphor Particles 2

α-sialon phosphor particles 2 were obtained in a manner the same as or similar to that of the α-sialon phosphor particles 1 except that each of the compounds as a raw material was weighed in a glove box in an inert gas atmosphere such that the molar ratio of each element was Ca:Eu:Si:Al=1.7:0.05:8.5:3.5 as a preparation amount, and the compounds were mixed to obtain a raw material mixture of the α-sialon phosphor. In the obtained α-sialon phosphor particles 2, the sum of k, m and n (“m+n” in the formula (I′)), the molar ratio of Si (“12−(m+n)” in the formula (I′)), and the molar ratio of Eu in the composition represented by the formula (I′) have the same numerical values as those of the α-sialon phosphor particles 1.

### Production of α-Sialon Phosphor Particles 3

α-sialon phosphor particles 3 were obtained in a manner the same as or similar to that of the α-sialon phosphor particles 1 except that each of the compounds as a raw material was weighed in a glove box in an inert gas atmosphere such that the molar ratio of each element was Ca:Eu:Si:Al=1.74:0.01:8.5:3.5 as a provision amount, and the compounds were mixed to obtain a raw material mixture of the α-sialon phosphor. The obtained α-sialon phosphor particles 3 have a composition represented by the formula (I′) in which k is 1.69, the sum of m and n (m+n) is 3.49, the molar ratio of Si is 8.51, and the molar ratio of Eu is 0.01.

### Production of α-Sialon Phosphor Particles 4

α-sialon phosphor particles 4 were obtained in a manner the same as or similar to that of the α-sialon phosphor particles 1 except that each of the compounds as a raw material was weighed in a glove box in an inert gas atmosphere such that the molar ratio of each element was Ca:Eu:Si:Al=1.745:0.005:8.5:3.5 as a provision amount, and the compounds were mixed to obtain a raw material mixture of the α-sialon phosphor. The obtained α-sialon phosphor particles 2 have a composition represented by the formula (I′) in which k is 1.68, the sum of m and n (m+n) is 3.49, the molar ratio of Si is 8.51, and the molar ratio of Eu is 0.004.

Each of the obtained α-sialon phosphor particles was subjected to the following analysis. The results of each analysis are set forth in Table 1.

### Mean Particle Diameter

The mean particle diameter (Fisher sub-sieve sizer's number) of each of the α-sialon phosphor particles was measured by the Fisher Sub-sieve sizer (FSSS) method using a Fisher Sub-Sieve Sizer Model 95 (manufactured by Fisher Scientific).

### Central Particle Diameter

A laser diffraction-type particle size distribution measuring device (MASTER SIZER 3000, manufactured by Malvern Instruments Ltd.) was used to measure the central particle diameter (median diameter) of each of the α-sialon phosphor particles in which cumulative frequency from the small diameter side in the volume-based particle size distribution is 50%.

### Light Emission Characteristics

Using a quantum efficiency measurement device (QE-2000 manufactured by Otsuka Electronics Co., Ltd.), each of the α-sialon phosphor particles was irradiated with excitation light having a wavelength of 450 nm, and the light emission spectrum thereof at room temperature (25° C.±5°) was measured. From the light emission spectrum of each of the α-sialon phosphor particles, the chromaticity coordinates (x, y) in the Commission Internationale de l'eclairage (CIE) 1931 chromaticity diagram were determined. In addition, in the light emission spectrum of each of the α-sialon phosphor particles, the wavelength at which the light emission intensity was maximum was determined as the light emission peak wavelength (λp) (nm). Further, the full width at half maximum (FWHM) of the light emission peak in the light emission spectrum of each of the α-sialon phosphor particles was determined. The half-width (full width at half maximum) means a wavelength width of the light emission spectrum at which a light emission intensity of 50% of the maximum light emission intensity is exhibited in the light emission spectrum.

### Reflection Spectra

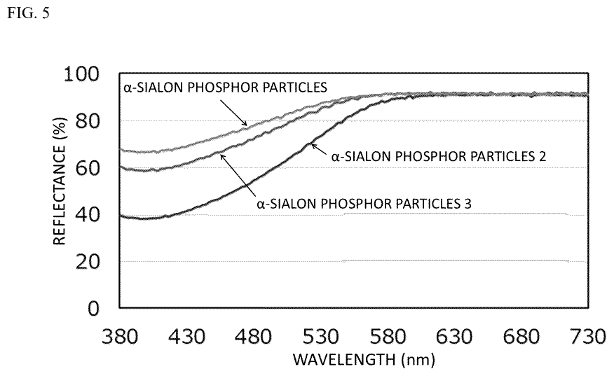

Using a fluorescence spectrophotometer (F-7100, manufactured by Hitachi High-Technologies Corporation), the sample of each of the α-sialon phosphor particles was irradiated with light from a halogen lamp serving as an excitation light source at room temperature (25° C.±5° C.), and the wavelengths on the excitation side and the fluorescent light side of fluorescence spectrophotometers were scanned to measure reflection spectra in a range of wavelength from 380 nm to 730 nm. Using a standard reflector (Spectralon (registered trademark), manufactured by Labsphere Inc.), the reflectance of the α-sialon phosphor particles was determined as a relative reflectance with reference to the reflectance of the standard reflector with respect to the excitation light at an excitation wavelength of 450 nm. The reflection spectra of the α-sialon phosphor particles 2 to 4 are shown in FIG. 5.

### Specific Surface Area by BET Method

The BET specific surface area of each of the α-sialon phosphor particles was measured by a BET method using a fully automatic specific surface area measuring device (Macsorb, manufactured by Mountech Co., Ltd.).

TABLE 1

| | | | | | Light | | |
|---|---|---|---|---|---|---|---|
| | | | | | emission | Fullwidth | BET |
| | Mean | Central | | | peak | at half | specific |
| | particle | particle | | | wavelength | maximum | surface |
| | diameter | diameter | coordinates | | λp | FWHM | area |
| | (μm) | (μm) | x | y | (nm) | (μm) | (m²/g) |
| α-sialon phosphor particles 1 | 1.4 | 2.8 | 0.5458 | 0.4518 | 593 | 85.3 | 2.22 |
| α-sialon phosphor particles 2 | 1.6 | 3.7 | 0.542 | 0.456 | 592 | 85.1 | 2.38 |
| α-sialon phosphor particles 3 | 1.3 | 3.3 | 0.522 | 0.474 | 586 | 87.3 | 2.56 |
| α-sialon phosphor particles 4 | 1.3 | 3.3 | 0.516 | 0.479 | 592 | 89.1 | 2.52 |

Each of the α-sialon phosphor particles has a BET specific surface area of 2.0 m²/g or more, and a mean particle diameter measured by the FSSS method is 0.1 μm or more and less than 5 μm.

FIG. 5 shows the reflection spectra of the α-sialon phosphor particles 2 to 4. The α-sialon phosphor particles 2 to 4 have a reflectance of 30% or more at a wavelength of 450 nm.

### Example 1-1

### Providing α-Sialon Phosphor Particles

The α-sialon phosphor particles 1 were provided.

### Providing Formed Body

One part by mass of yttrium oxide particles was mixed with 100 parts by mass of the α-sialon phosphor particles 1 to obtain a raw material mixture. The yttrium oxide particles were 99.9 mass % pure, had a BET specific surface area of 14.4 m²/g, and had a mean particle diameter measured by laser diffractometry of 0.50 μm. The BET specific surface area of the yttrium oxide particles was measured in a manner the same as or similar to that in the measurement of the BET specific surface area of the α-sialon phosphor particles 1. For the mean particle diameter of the yttrium oxide particles, reference was made to catalog values. In the table, the yttrium oxide particles are represented as Y₂O₃ particles. The raw material mixture was composed of only the α-sialon phosphor particles 1 and the yttrium oxide particles, and 100 mass % of the raw material mixture was the same as 100 mass % of the total amount of the α-sialon phosphor particles 1 and yttrium oxide particles, and the remainder excluding the yttrium oxide particles in the raw material mixture was the α-sialon phosphor particles 1. The content of the α-sialon phosphor particles 1 in 100 mass % of the raw material mixture was 99 mass %.

The raw material mixture was provided in a mold, and pressed at a pressure of 2 MPa to mold a cylindrical formed body having a diameter of 28.5 m and a thickness of 9.3 mm. The formed body was further subjected to CIP forming at a pressure of 352.8 MPa to form a cylindrical formed body having a diameter of 26.2 mm and a thickness of 8.9 mm.

### Placing Formed Body in Container

The obtained formed body was placed in a container containing pyrolytic boron nitride. A PBN crucible was used as the container containing pyrolytic boron nitride. The formed body was placed such that a surface thereof having the largest area was in contact with the bottom surface of the PBN crucible. In the formed body, the first sintered compact, and the second sintered compact, a surface having the largest area is also referred to as a main surface. When the formed body, the first sintered compact, and the second sintered compact are plate-like bodies, they may have two main surfaces facing each other.

### Disposing First Lid

A first lid containing pyrolytic boron nitride was disposed at the opening of the container in which the formed body was placed. As the first lid containing pyrolytic boron nitride, a first lid having a size enough for closing the opening of the container was used. In disposing the first lid, a weight was disposed on the first lid to apply a load to the first lid. As the weight, a weight of tungsten metal was used. The load of the weight reduced the gap between the opening of the container and the first lid.

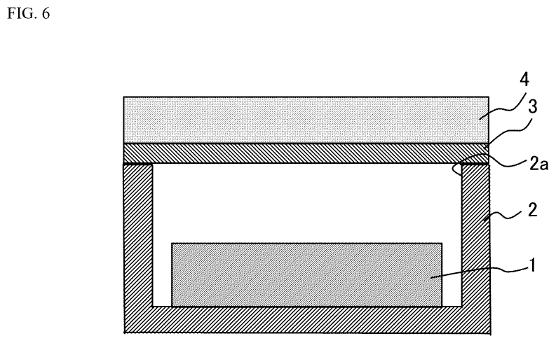

FIG. 6 is a cross-sectional view schematically illustrating a formed body 1 placed in a container 2 containing pyrolytic boron nitride. The formed body 1 was placed in the container 2 containing pyrolytic boron nitride, and an opening 2a of the container 2 was closed by a first lid 3. A weight 4 was disposed on the first lid 3, and the gap between the opening 2a of the container 2 and the first lid 3 was reduced by the load of the weight 4. The container 2 containing pyrolytic boron nitride and the first lid 3 containing pyrolytic boron nitride were dense, the α-sialon phosphor particles in the formed body 1 were decomposed and gasified by the heat of the primary firing, and the decomposition gas was present around the formed body 1; thus, the internal pressure in the container 2 is increased.

### Obtaining First Sintered Compact

The formed body in the PBN crucible in which the opening was closed with the first lid loaded with the weight was put in a firing furnace (manufactured by Fuji Dempa Kogyo Co., Ltd.). The formed body in the PBN crucible was subjected to the primary firing at 1850° C. and 0.92 MPa for 5 hours in a non-oxidizing atmosphere containing 99.9 vol % or more of nitrogen and the remainder (0.1 vol % or less) of oxygen in the firing furnace to obtain the first sintered compact containing an α-sialon phosphor crystal phase.

### Slicing First Sintered Compact

The obtained first sintered compact was sliced to a thickness of 380 μm by using a wire saw.

### Obtaining Second Sintered Compact

The sliced first sintered compact was placed in a PBN crucible, which is a container containing pyrolytic boron nitride. The sliced first sintered compact was placed such that the main surface thereof was in contact with the bottom surface of the PBN crucible. The first lid containing pyrolytic boron nitride was disposed at the opening of the container in which the first sintered compact was placed so as to close the opening. A weight formed of tungsten metal was disposed on the first lid. The load of the weight reduced the gap between the opening of the container and the first lid. The first sintered compact in the PBN crucible in which the opening was closed with the first lid loaded with the weight was put in a firing furnace (manufactured by Fuji Dempa Kogyo Co., Ltd.). The first sintered compact in the PBN crucible was subjected to the secondary firing at 1700° C. and 0.92 MPa for 1 hour in a non-oxidizing atmosphere containing 99.9 vol % or more of nitrogen and the remainder (0.1 vol % or less) of oxygen in the firing furnace to obtain the second sintered compact containing an α-sialon phosphor crystal phase.

### Example 1-2

The second sintered compact containing an α-sialon phosphor crystal phase was obtained in a manner the same as or similar to that in Example 1-1 except that in obtaining the second sintered compact after the first sintered compact was obtained, the temperature of the secondary firing was set to 1725° C.

### Example 1-3

The second sintered compact containing an α-sialon phosphor crystal phase was obtained in a manner the same as or similar to that in Example 1-1 except that in obtaining the second sintered compact after the first sintered compact was obtained, the temperature of the secondary firing was set to 1675° C.

### Example 1-4

The second sintered compact containing an α-sialon phosphor crystal phase was obtained in a manner the same as or similar to that in Example 1-1 except that in obtaining the second sintered compact after the first sintered compact was obtained, the temperature of the secondary firing was set to 1750° C.

The following measurement was performed on the obtained first sintered compact and second sintered compact. Conditions and measurement results in each example are shown in Table 2. In each of Tables 2 to 5, the container containing pyrolytic boron nitride, the first lid containing pyrolytic boron nitride, and the second lid containing pyrolytic boron nitride to be described later are represented by PBN, and when the weight is tungsten metal, it is represented by W. In each of Tables 2 to 5, the symbol “-” indicates that there is no corresponding item.

### Relative Density (%)

The relative density of the obtained first sintered compact and the relative density of the obtained second sintered compact were calculated by the calculation formulas (1) and (2). Because the content of the α-sialon phosphor particles in the raw material mixture was 99 mass %, the content of yttrium oxide was not considered, and 100% of the raw material mixture was regarded as the α-sialon phosphor particles, and the true density of the α-sialon phosphor particles was regarded as the true density of the sintered compact. The true density of the α-sialon phosphor particles was 3.2 g/cm³.

### Chromaticity Coordinates (x, y)

Each of the second sintered compacts was mounted on a light-emitting element (LED) having a light emission peak wavelength of 455 nm to obtain a sample of the light-emitting device. In a sample of each light-emitting device, a current of 1 A was made to flow through the light-emitting element to irradiate each ceramic sintered compact with excitation light, and the chromaticity coordinates (x, y) of the CIE 1931 chromaticity diagram of fluorescence emitted from the ceramic sintered compact were measured using a multi-channel spectrometer (Hamamatsu Photonics K.K., the product name: PMA-12).

TABLE 2

| | | | | | | | | | | First | | | |
|---|---|---|---|---|---|---|---|---|---|---|---|---|---|
| | Raw material mixture | | | | | | | | | sintered | | | |
| | α-sialon | | | | | | | Primary | Secondary | compact | Second sintered compact | | |
| | phosphor | | Y₂0₃ | | | | | firing | firing | Relative | Relative | Chromaticity | |
| | particles | | particles | | First | Second | | temperature | temperature | density | density | coordinates | |
| | Type | (Mass %) | (mass %) | Container | lid | lid | Weight | (° C.) | (° C.) | (%) | (%) | x | y |
| Example 1-1 | 1 | 99 | 1 | PBN | PBN | — | W | 1850 | 1700 | 103.3 | 103.9 | — | — |
| Example 1-2 | 1 | 99 | 1 | PBN | PBN | — | W | 1850 | 1725 | 103.3 | 105.0 | 0.589 | 0.411 |
| Example 1-3 | 1 | 99 | 1 | PBN | PBN | — | W | 1850 | 1675 | 103.3 | 106.1 | 0.589 | 0.411 |
| Example 1-4 | 1 | 99 | 1 | PBN | PBN | — | W | 1850 | 1750 | 103.3 | 102.9 | 0.590 | 0.409 |

Regarding the first sintered compact and the second sintered compact of Examples 1-1 to 1-4, the formed body was placed in a container containing pyrolytic boron nitride, the first lid was disposed at the opening of the container, the first lid was loaded with a weight to reduce the gap between the opening of the container and the first lid, and the primary firing or the secondary firing was performed in a state in which decomposition gas resulting from decomposition and gasification of α-sialon phosphor particles by the heat of the primary firing or the secondary firing was present around the formed body or the first sintered compact in the container, so that the obtained first sintered compact or the second sintered compact had a high relative density.

The first sintered compact and the second sintered compact of Examples 1-1 to 1-4 contained yttrium oxide particles in the raw material mixture in providing the formed body, so that in performing the primary firing to obtain the first sintered compact, the yttrium oxide particles also reacted with the α-sialon phosphor particles when the α-sialon phosphor particles reacted with each other by the primary firing to cause crystal growth, part of the elements constituting the composition of the α-sialon phosphor particles was substituted with yttrium, and the reaction between the α-sialon phosphor particles was activated, thereby acting on the rate of crystal growth to obtain the first and second sintered compacts containing a dense α-sialon phosphor crystal phase with few voids.

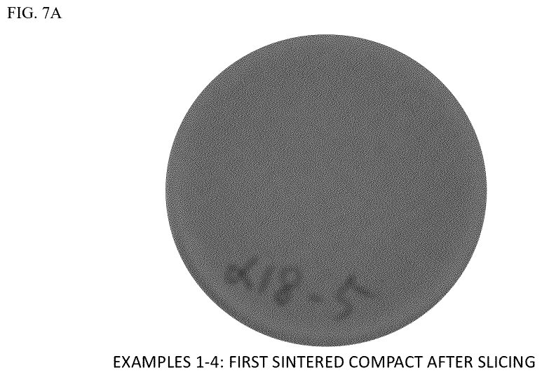

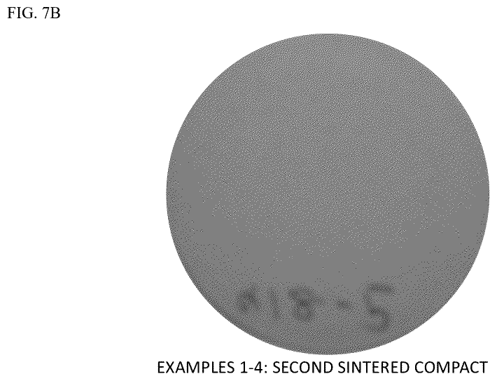

FIG. 7A is a photograph showing the appearance of the main surface of the first sintered compact after slicing of Example 1-4, and FIG. 7B is a photograph showing the appearance of the main surface of the second sintered compact of Example 1-4. The characters written on the surfaces of the first sintered compact in FIG. 7A and the second sintered compactor in FIG. 7B are symbols for distinguishing sample numbers. As shown in FIG. 7A, the first sintered compact obtained after the primary firing was dark and dull in body color due to remaining impurities and the like. As shown in FIG. 7B, by the secondary firing, the darkening and dullness remaining on the surfaces of the first sintered compact were decomposed and released as a gas, and the obtained second sintered compact had the body color (bright orange-yellow) of the α-sialon phosphor crystal phase.

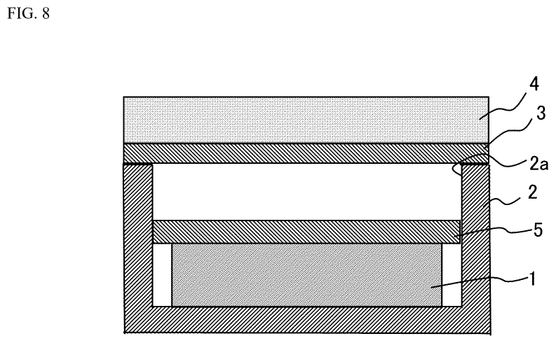

FIG. 8 is a cross-sectional view schematically illustrating the formed body 1 placed in the container 2 containing pyrolytic boron nitride. The formed body 1 is placed in the container 2 containing pyrolytic boron nitride, and the opening 2a of the container 2 is closed by the first lid 3. The weight 4 is disposed on the first lid 3, and the gap between the opening 2a of the container 2 and the first lid 3 is reduced by the load of the weight 4. A second lid 5 containing pyrolytic boron nitride was disposed in the container 2 so as to be in contact with the formed body 1 in the container 2. By disposing the second lid 5 in the container 2 so as to be in contact with the formed body 1 in the container 2, the decomposition gas resulting from the decomposition of the α-sialon phosphor particles in the formed body 1 by the heat of the primary firing is likely to be present at a higher concentration around the formed body, so that the internal pressure around the formed body 1 in the container 2 is further increased, and the relative density of the obtained first sintered compact can be increased.

### Example 2

The second sintered compact was obtained in a manner the same as or similar to that in Example 1-1 except that in providing the α-sialon phosphor particles 2 and in placing the formed body in the container, the second lid containing pyrolytic boron nitride was disposed in the container so as to be in contact with the formed body in the container, and in obtaining the first sintered compact, the first sintered compact was obtained, setting the temperature of the primary firing to 1875° C.

### Example 3

The second sintered compact was obtained in a manner the same as or similar to that in Example 1-1 except that in providing the α-sialon phosphor particles 3 and in placing the formed body in the container, the second lid containing pyrolytic boron nitride was disposed in the container so as to be in contact with the formed body in the container.

### Example 4

The second sintered compact was obtained in a manner the same as or similar to that in Example 1-1 except that in providing the α-sialon phosphor particles 3 and in placing the formed body in the container, the second lid containing pyrolytic boron nitride was disposed in the container so as to be in contact with the formed body in the container, and in obtaining the first sintered compact, the first sintered compact was obtained, setting the temperature of the primary firing to 1875° C.

### Example 5

The second sintered compact was obtained in a manner the same as or similar to that in Example 1-1 except that in providing the α-sialon phosphor particles 4 and in placing the formed body in the container, the first sintered compact was obtained by disposing the second lid containing pyrolytic boron nitride in the container so as to be in contact with the formed body in the container.

### Example 6

The second sintered compact was obtained in a manner the same as or similar to that in Example 1-1 except that in providing the α-sialon phosphor particles 4 and in placing the formed body in the container, the second lid containing pyrolytic boron nitride was disposed in the container so as to be in contact with the formed body in the container, and in obtaining the first sintered compact, the first sintered compact was obtained, setting the temperature of the primary firing to 1875° C.

The obtained first sintered compact and second sintered compact were subjected to measurement in a manner the same as or similar to those in Examples 1-1 to 1-4. The conditions and measurement results in each example are shown in Table 3.

TABLE 3

| | | | | | | | | | | First | | | |
|---|---|---|---|---|---|---|---|---|---|---|---|---|---|
| | Raw material mixture | | | | | | | | | sintered | | | |
| | α-sialon | | | | | | | Primary | Secondary | compact | Second sintered compact | | |
| | phosphor | | Y₂0₃ | | | | | firing | firing | Relative | Relative | Chromaticity | |
| | particles | | particles | | First | Second | | temperature | temperature | density | density | coordinates | |
| | Type | (Mass %) | (mass %) | Container | lid | lid | Weight | (° C.) | (° C.) | (%) | (%) | x | y |
| Example 2 | 2 | 99 | 1 | PBN | PBN | PBN | W | 1875 | 1700 | 96.4 | 96.4 | 0.5907 | 0.412 |
| Example 3 | 3 | 99 | 1 | PBN | PBN | PBN | W | 1850 | 1700 | 97.5 | 96.8 | — | — |
| Example 4 | 3 | 99 | 1 | PBN | PBN | PBN | W | 1875 | 1700 | 99.5 | 99.7 | 0.5404 | 0.4514 |
| Example 5 | 4 | 99 | 1 | PBN | PBN | PBN | W | 1850 | 1700 | 97.6 | 97.9 | — | — |
| Example 6 | 4 | 99 | 1 | PBN | PBN | PBN | W | 1875 | 1700 | 99.5 | 99.7 | 0.5088 | 0.4413 |

Regarding the first sintered compact and the second sintered compact of Examples 2 to 6, the formed body was placed in a container containing pyrolytic boron nitride, the second lid containing pyrolytic boron nitride was placed so as to be in contact with the formed body in the container, the first lid was placed at the opening of the container, and a load is applied to the first lid with the weight to reduce the gap between the opening of the container and the first lid. The primary firing or the secondary firing was performed in a state in which the decomposition gas resulting from decomposition and gasification of the α-sialon phosphor particles by the heat of the primary firing or the secondary firing was present at a higher concentration around the formed body or the first sintered compact in the container. Therefore, it is presumed that the internal pressure in the container was further increased, and the relative density of the obtained first sintered compact or the obtained second sintered compact was increased.

Regarding the first sintered compact and the second sintered compact of Examples 2 to 6, because yttrium oxide particles were contained in the raw material mixture in providing the formed body, in performing the primary firing to obtain the first sintered compact, the yttrium oxide particles also reacted with the α-sialon phosphor particles when the α-sialon phosphor particles reacted with each other by the primary firing to cause crystal growth, part of the elements constituting the composition of the α-sialon phosphor particles was substituted with yttrium, and the reaction between the α-sialon phosphor particles was activated, thereby acting on the rate of crystal growth to obtain the first sintered compact and the second sintered compact containing a dense α-sialon phosphor crystal phase with few voids.

### α-Sialon Phosphor Crystal Phase and Sub-Phase

For the sintered compact according to Example 2 and the sintered compact according to Example 4, the content ratios of the α-sialon phosphor crystal phase and the sub-phase were measured by a reference intensity ratio (RIR) method in the measurement by a powder X-ray diffraction (XRD) method using CuK α rays.

The sintered compact according to Example 2 had a composition included in the composition represented by the formula (I), specifically, the content ratio of the α-sialon phosphor crystal phase having a composition represented by (Ca_{0.704}Y_{0.296})₂Si_{9.134}Al_{2.866}O_{1.09}N_{14.91}:Eu was 100.0 mass %.

The sintered compact according to Example 6 had a composition included in the composition represented by the formula (I), specifically, the content ratio of the α-sialon phosphor crystal phase having a composition represented by (Ca_{0.704}Y_{0.296})₂Si_{9.134}Al_{2.866}O_{1.09}N_{14.91}:Eu was 87.2 mass %, and the content ratio of the sub-phase having a composition represented by Ca₂Si₅N₈, which is a composition represented by the formula (II), was 12.8 mass %.

### Comparative Example 1

The first sintered compact was obtained in a manner the same as or similar to that in Example 1-1 except that in providing the formed body, a formed body was provided that was formed using only α-sialon phosphor particles as the raw material without containing yttrium oxide particles, in disposing the first lid, the first lid containing boron nitride (BN) was disposed at the opening of the container, and no load was applied to the first lid by disposing no weight on the first lid, and in obtaining the first sintered compact, the temperature of the primary firing was set to 1900° C.

### Comparative Example 2

The first sintered compact was obtained in a manner the same as or similar to that in Example 1-1 except that in providing the formed body, a formed body was provided that was formed using only α-sialon phosphor particles as the raw material without containing yttrium oxide particles, and in obtaining the first sintered compact, the temperature of the primary firing was set to 1900° C.

### Comparative Example 3

The first sintered compact was obtained in a manner the same as or similar to that in Example 1-1 except that in placing the formed body in the container, and in obtaining the first sintered compact, the temperature of the primary firing was set to 2000° C.

### Comparative Example 4

The first sintered compact was obtained in a manner the same as or similar to that in Example 1-1 except that in providing the α-sialon phosphor particles, the α-sialon phosphor particles 4 were provided, and in disposing the first lid, no weight was disposed on the first lid and no load was applied to the first lid.

The obtained first sintered compact was subjected to measurement in a manner the same as or similar to that in Example 1-1. The conditions and measurement results in each example are shown in Table 4.

TABLE 4

| | | | | | | | | | | First | | | |
|---|---|---|---|---|---|---|---|---|---|---|---|---|---|
| | Raw material mixture | | | | | | | | | sintered | | | |
| | α-sialon | | | | | | | Primary | Secondary | compact | Second sintered compact | | |
| | phosphor | | Y₂0₃ | | | | | firing | firing | Relative | Relative | Chromaticity | |
| | particles | | particles | | First | Second | | temperature | temperature | density | density | coordinates | |
| | Type | (Mass %) | (mass %) | Container | lid | lid | Weight | (° C.) | (° C.) | (%) | (%) | x | y |
| Comparative | 1 | 100 | 0 | PBN | BN | — | — | 1900 | — | 68.4 | — | — | — |
| Example 1 | | | | | | | | | | | | | |
| Comparative | 1 | 100 | 0 | PBN | PBN | — | W | 1900 | — | 83.5 | — | — | — |
| Example 2 | | | | | | | | | | | | | |
| Comparative | 1 | 99 | 0 | PBN | PBN | — | W | 2000 | — | 89.5 | — | — | — |
| Example 3 | | | | | | | | | | | | | |
| Comparative | 4 | 99 | 1 | PBN | PBN | — | — | 1850 | — | 95.7 | — | — | — |
| Example 4 | | | | | | | | | | | | | |

Because the first sintered compact according to Comparative Example 1 did not contain yttrium oxide particles in the raw material mixture, the reaction between the α-sialon phosphor particles was not activated, and because the first lid was not a first lid containing pyrolytic boron nitride (PBN) but a first lid containing boron nitride (BN), the decomposition gas resulting from decomposition and gasification of the α-sialon phosphor particles by the heat of the primary firing was released to the outside of the container, and the relative density of the obtained first sintered compact was as low as 68.4%.

Because the first sintered compact according to Comparative Example 2 did not contain yttrium oxide particles in the raw material mixture, the reaction between the α-sialon phosphor particles was not activated, and the relative density of the obtained first sintered compact was as low as 83.5%.

In the first sintered compact according to Comparative Example 3, although the temperature of the primary firing was set to 2000° C., the yttrium oxide particles were not contained in the raw material mixture, and the reaction between the α-sialon phosphor particles was not sufficiently activated, so that the relative density of the obtained first sintered compact was as low as 89.5%.

The first sintered compact according to Comparative Example 4 contained yttrium oxide particles in the raw material mixture, and the container was a container containing pyrolytic boron nitride (PBN), but the decomposition gas resulting from decomposition and gasification of the α-sialon phosphor particles by the heat of a high temperature of 1850° C. in the primary firing was released to the outside of the container, so that the relative density of the obtained first sintered compact was as low as 95.7%.

### Example 7

α-sialon phosphor particles 3 are provided.

As shown in Table 4, 0.1 parts by mass of yttrium oxide particles was mixed with 100 parts by mass of the α-sialon phosphor particles 3 to obtain a raw material mixture. The content of the yttrium oxide particles in 100 mass % of the raw material mixture was 0.1 mass %. The yttrium oxide particles were 99.9 mass % pure, had a BET specific surface area of 14.4 m²/g, and had a mean particle diameter measured by laser diffractometry of 0.50 μm. The BET specific surface area of the yttrium oxide particles was measured in a manner the same as or similar to that in the measurement of the BET specific surface area of the α-sialon phosphor particles 1. For the mean particle diameter of the yttrium oxide particles, reference was made to catalog values. In the table, the yttrium oxide particles are represented as Y₂O₃ particles.

The α-sialon phosphor particles and the yttrium oxide particles were stirred at 1000 rpm for 15 hours using 15 to 20 alumina media having a diameter of 20 mm in a ball-mill having a volume of 500 mL, 7 parts by mass of ethanol as a forming aid was added to 100 parts by mass of the total amount of the α-sialon phosphor particles 3 and the yttrium oxide particles as a raw material mixture, and the mixture was stirred at 1000 rpm for 0.5 hours (30 minutes).

The raw material mixture contained the α-sialon phosphor particles 3 and yttrium oxide particles, and 100 mass % of the raw material mixture was 100 mass % of the total amount of the α-sialon phosphor particles 3 and the yttrium oxide particles. The content of the yttrium oxide particles in 100 mass % of the raw material mixture was 0.1 mass %, and the content of the α-sialon phosphor particles 3 was 99.9 mass %.

The first sintered compact and the second sintered compact were obtained in a manner the same as or similar to that in Example 1-1 except that the raw material mixture was supplied in a mold, and CIP forming was performed in a manner the same as or similar to that in Example 1-1 to form a cylindrical formed body having a diameter of 26.2 mm and a thickness of 8.9 mm, so that the formed body was provided as described above.

### Example 8

The first sintered compact and the second sintered compact were obtained in a manner the same as or similar to that in Example 7 except that the content of the yttrium oxide particles was 1.0 mass % and the content of the α-sialon phosphor particles was 99.0 mass % in 100 mass % of the raw material mixture.

### Example 9

The first sintered compact and the second sintered compact were obtained in a manner the same as or similar to that in Example 7 except that the content of the yttrium oxide particles was 3.0 mass % and the content of the α-sialon phosphor particles was 97.0 mass % in 100 mass % of the raw material mixture.

### Example 10

The first sintered compact and the second sintered compact were obtained in a manner the same as or similar to that in Example 7 except that the content of the yttrium oxide particles was 5.0 mass % and the content of the α-sialon phosphor particles was 95.0 mass % in 100 mass % of the raw material mixture.

### Example 11

The first sintered compact and the second sintered compact were obtained in a manner the same as or similar to that in Example 7 except that the content of the yttrium oxide particles was 6.0 mass % and the content of the α-sialon phosphor particles was 94.0 mass % in 100 mass % of the raw material mixture.

### Relative Density (%)

The relative density of the obtained first sintered compact and the relative density of the obtained second sintered compact were calculated by the calculation formulas (1) to (5). The true density of the α-sialon phosphor particles was 3.2 g/cm³. The true density of the yttrium oxide particles was 5.01 g/cm³. The results are shown in Table 5 below.

TABLE 5

| | | | | | | | | | | First | Second |
|---|---|---|---|---|---|---|---|---|---|---|---|
| | Raw material mixture | | | | | | | | | sintered | sintered |
| | α-sialon | | | | | | | Primary | Secondary | compact | compact |
| | phosphor | | Y₂0₃ | | | | | firing | firing | Relative | Relative |
| | particles | | particles | | First | Second | | temperature | temperature | density | density |
| | Type | (Mass %) | (mass %) | Container | lid | lid | Weight | (° C.) | (° C.) | (%) | (%) |
| Example 7 | 3 | 99.9 | 0.1 | PBN | PBN | PBN | W | 1875 | 1700 | 100 | 99.7 |
| Example 8 | 3 | 99.0 | 1.0 | PBN | PBN | PBN | W | 1875 | 1700 | 100 | 101.1 |
| Example 9 | 3 | 97.0 | 3.0 | PBN | PBN | PBN | W | 1875 | 1700 | 100 | 100.4 |
| Example 10 | 3 | 95.0 | 5.0 | PBN | PBN | PBN | W | 1875 | 1700 | 100 | 100.4 |
| Example 11 | 3 | 94.0 | 6.0 | PBN | PBN | PBN | W | 1875 | 1700 | 100 | 98.3 |

Regarding the first sintered compact and the second sintered compact according to Examples 7 to 11, in providing the formed body, when the total amount of the α-sialon phosphor particles and the yttrium oxide particles contained in the raw material mixture was 100 mass %, the amount of the yttrium oxide particles was in a range from 0.1 mass % to 6.0 mass %, the relative density of each first sintered compact was 100%, and the relative density of each second sintered compact was 96% or more, specifically 98% or more; thus, the relative densities were increased. In Examples 7 to 11, the formed body or the second sintered compact was placed in a container containing pyrolytic boron nitride, the first lid was disposed at the opening of the container, and the first lid was loaded with a weight to reduce the gap between the opening of the container and the first lid. The primary firing or the secondary firing was performed in a state in which the decomposition gas resulting from decomposition and gasification of the α-sialon phosphor particles by the heat of the primary firing or the secondary firing was present around the formed body or the first sintered compact in the container, so that the relative density of the obtained first sintered compact or second sintered compact was increased.

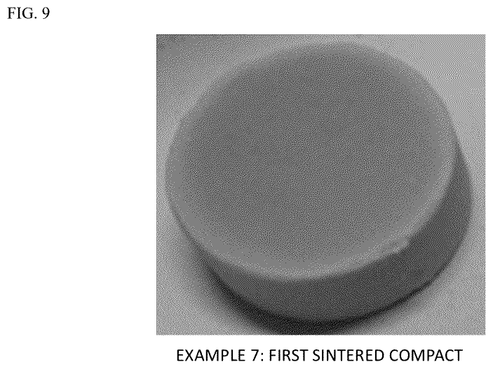

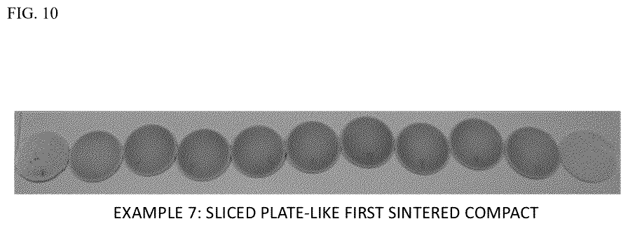

FIG. 9 is a photograph showing the appearance of the first sintered compact of Example 7. The body color of the first sintered compact according to Example 7 was dark and dull. FIG. 10 is a photograph showing the appearance of the first sintered compact obtained by slicing the first sintered compact according to Example 7 shown in FIG. 9 into a plate-like shape having a thickness of 380 μm. When the first sintered compact is sliced to a thickness of 2 mm or less, the body color of the first sintered compact is darker and duller at the center portion in the thickness direction than at the surfaces of the first sintered compact.

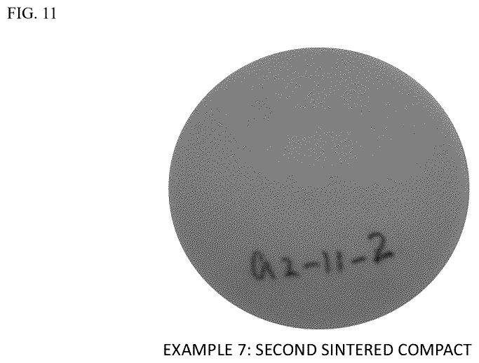

FIG. 11 is a photograph showing the appearance of the main surface of the second sintered compact of Example 7. The characters written on the surface of the second sintered compact in FIG. 11 are symbols for distinguishing sample numbers.

As shown in FIG. 11, by the secondary firing, the darkening and dullness remaining on the surface of the first sintered compact were decomposed and released as a gas, and the obtained second sintered compact had the body color (bright orange-yellow) of the α-sialon phosphor crystal phase.

The sintered compact obtained by the manufacturing method of the present disclosure can be used, as a wavelength conversion member that can convert the wavelength of light emitted from an LED or an LD, in a light-emitting device used as a light source for vehicle-mounted application, general lighting use, a backlight of a liquid crystal display device, illumination, a projector, or the like. The ceramic sintered compact obtained by the manufacturing method of the present disclosure emits light by irradiation with excitation light, and can be used as a material for a solid scintillator.

What is claimed is:

1. A method for manufacturing a sintered compact, comprising:
providing α-sialon phosphor particles;
providing a formed body comprising forming a raw material mixture obtained by mixing the α-sialon phosphor particles and yttrium oxide particles;
placing the formed body in a container containing pyrolytic boron nitride;
disposing a first lid containing pyrolytic boron nitride at an opening of the container; and
obtaining a first sintered compact containing an α-sialon phosphor crystal phase by subjecting the formed body in the container having the opening closed with the first lid to primary firing at a temperature in a range of 1800° C. to 2000° C.

2. The method for manufacturing a sintered compact, according to claim 1, further comprising:
slicing the first sintered compact into a first product having a plate-like shape; and
obtaining a second sintered compact containing an α-sialon phosphor crystal phase by subjecting the first product to secondary firing at a temperature of 1600° C. or more and less than 1800° C.

3. The method for manufacturing a sintered compact, according to claim 2, wherein
the obtaining of the second sintered compact comprises:
placing the first product in the container containing pyrolytic boron nitride; and
disposing the first lid containing pyrolytic boron nitride at the opening of the container.

4. The method for manufacturing a sintered compact, according to claim 1, wherein the raw material mixture contains the yttrium oxide particles in a range of 0.1 mass % to 6.0 mass % when a total of the α-sialon phosphor particles and the yttrium oxide particles is 100 mass %.

5. The method for manufacturing a sintered compact, according to claim 2, wherein the slicing of the first sintered compact comprises slicing the first sintered compact to a thickness of 2 mm or less.

6. The method for manufacturing a sintered compact, according to claim 1, wherein the placing of the formed body in the container comprises disposing a second lid containing pyrolytic boron nitride in the container in a manner that the second lid is in contact with the formed body in the container.

7. The method for manufacturing a sintered compact, according to claim 1, wherein the disposing of the first lid comprises applying a load to the first lid.

8. The method for manufacturing a sintered compact, according to claim 7, wherein the applying the load to the first lid comprises disposing a weight on the first lid, the weight containing at least one selected from the group consisting of tungsten, molybdenum, and tantalum.

9. The method for manufacturing a sintered compact, according to claim 1, wherein, in the providing of the α-sialon phosphor particles, the α-sialon phosphor particles have a BET specific surface area of 2.0 m²/g or more and a light reflectance of 30% or more at a wavelength of 450 nm.

10. The method for manufacturing a sintered compact, according to claim 1, wherein the primary firing is performed in a non-oxidizing atmosphere pressurized in a range of 0.5 MPa to 200 MPa.

11. The method for manufacturing a sintered compact, according to claim 1, wherein in the providing of the formed body, a remainder excluding the yttrium oxide particles in the raw material mixture is the α-sialon phosphor particles.

12. The method for manufacturing a sintered compact, according to claim 2, wherein the obtaining of the second sintered compact comprises performing the secondary firing in a non-oxidizing atmosphere pressurized in a range of 0.5 MPa to 200 MPa.

13. A sintered compact comprising an α-sialon phosphor crystal phase, wherein the sintered compact has a relative density of 96% or more.

14. The sintered compact according to claim 13, wherein the α-sialon phosphor crystal phase has a composition represented by Formula (I):
$$( {Ca}_{1 - q} {Y}_{q} ) {Si}_{12 - ( m + n )} {Al}_{( m + n )} {O}_{n} {N}_{16 - n} : Eu , \qquad ( I )$$
where in Formula (I), k, m, n, and q satisfy 1.0≤k≤2.0, 2.0≤m≤6.0, 0≤n≤1.0, and 0.001≤q≤0.35, respectively.

15. The sintered compact according to claim 13, further comprising a sub-phase, wherein the sub-phase has a composition represented by Formula (II):
$${Ca}_{2} {Si}_{5} {N}_{8} . \qquad ( II )$$
